(19) United States
(12) Patent Application Publication
(10) Pub. No.: US 2025/0128272 A1
(43) Pub. Date: Apr. 24, 2025

(54) FLOTATION UNIT AND FLOTATION METHOD

(71) Applicant: METSO FINLAND OY, Espoo (FI)

(72) Inventors: Marly de Avila Carvalho, Helsinki (FI); Ian Michael Sherrell, Columbia, MD (US); Enkhzul Bayarmagnai, Pori (FI)

(73) Assignee: METSO FINLAND OY, Espoo (FI)

(21) Appl. No.: 18/490,199

(22) Filed: Oct. 19, 2023

(51) Int. Cl. B03D 1/14; B03D 1/24

(52) U.S. Cl. CPC B03D 1/1412; B03D 1/24

(57) ABSTRACT

A froth flotation unit including a flotation tank, a froth collecting launder having a froth overflow lip and a near coarse launder having a second lip. The second lip is arranged closer to the bottom of the flotation tank than the froth overflow lip. A froth flotation method for treating coarse particles suspended in slurry in the froth flotation unit is also provided.

### FIELD OF TECHNOLOGY

The invention relates to a flotation tank of a froth flotation unit. The invention also relates to a froth flotation method for treating coarse mineral ore particles suspended in slurry and separating slurry into a first overflow, a second overflow and an underflow.

### BACKGROUND

Generally, in conventional flotation, such as when using conventional mechanically agitated flotation cells, underflow from a first primary flotation section may comprise considerable amounts of coarser particles of valuable mineral(s) mixed with finer gangue particles. Conventional mechanical flotation cells are best suited for separation of particles within a size range of approximately 20 μm to 150 μm. Consequently, coarse particles having a size greater than 150 μm must be grinded for the recovery with conventional mechanical flotation cells. The grinding is very energy intensive and not sustainable in the long term since the ore reserves grades are getting lower. Therefore, to maintain the same level of production, the volume of the raw ore material must be increased, and the flotation plants must be adapted to higher throughputs.

As such, there is a need for improved technologies for the recovery of coarse particles. There is also a need for technologies where particles within a size range of approximately 20 μm to 150 μm and particles within a size of greater than 150 μm can be simultaneously recovered.

### OBJECT OF THE INVENTION

The object of the invention is to provide an improved froth flotation unit and method capable of recovering particles and coarse particles.

### SUMMARY

The object of the invention can be achieved by the froth flotation unit according to claim 1.

According to a first aspect, a froth flotation unit is provided, the froth flotation unit comprising:
a flotation tank having a top, bottom and one or more wall(s);
a froth collecting launder having a froth overflow lip; and
a near coarse launder having a second lip;
wherein the second lip is arranged closer to the bottom of the flotation tank than the froth overflow lip.

According to a second aspect, a froth flotation method for treating coarse particles suspended in slurry is provided, wherein the slurry is separated into a first overflow, a second overflow and an underflow in a froth flotation unit according to the first aspect.

### Definitions

This summary of definitions is provided to introduce a selection of concepts in a simplified form that are further described below in the detailed description. This summary is not intended to identify key features or essential features of the claimed subject matter, nor is it intended to be used to limit the scope of the claimed subject matter.

Throughout this specification, “particles” may refer to particles within a size range of approximately 20 μm to 150 μm and “coarse particles” may refer to particles having a size greater than 150 μm.

Also, “flotation” may refer to separation of a mixture by adhering a substance in said mixture at an interface. In flotation, separation of a mixture may be based on differences in the hydrophobicity of substances in said mixture. Herein, “separation” may refer to the extraction or removal of a substance from a mixture for use or rejection.

Further, “froth flotation” may refer to flotation, wherein froth is utilized for separation. Herein, “froth” may refer to a dispersion, comprising a greater portion by volume of flotation gas dispersed as bubbles in lesser portion by volume of a flotation liquid. Generally, froth may or may not be stabilized by solid particles.

In this disclosure a “froth layer” may refer to a layer comprising, or comprising substantially, or consisting essentially of, or consisting of froth in a flotation tank, when said flotation tank is in use.

In this disclosure “froth slurry interface” may refer to a layer on top of the slurry where gas hold-up percentage is between 10-50.

Herein, a “froth depth” may refer to a thickness of a froth layer in a flotation tank. A froth depth may be measurable as a vertical distance between a launder lip and a surface of a slurry in a flotation tank, when said flotation tank is in use. However, the skilled person will understand that since froth is overflowing the launder lip when said flotation tank is in use, the froth depth may be measurable from slightly above the launder lip.

Throughout this specification, slurry being “fed to a froth layer zone” may refer to feeding said slurry onto, and/or into, said froth layer zone, and/or into the froth slurry interface.

Further, “slurry” may refer to a dispersion, comprising solid particles or coarse particles suspended in a continuous phase of flotation liquid.

In this disclosure “launder” may refer to a channel or trough for conveying a medium.

Further, “the top of the flotation tank” may refer to the upper boundary of a flotation tank when the flotation tank rests on the surface on which it is placed.

Throughout this specification “froth layer zone” may refer to the volume of a flotation tank, where the froth layer is present during froth flotation. Further, “a central froth layer cross section” may refer to a horizontal cross section in the froth layer zone, wherein the distance of the cross section to the upper surface of the froth layer zone and the lower surface of the froth layer zone is equal. “Upper froth layer surface” may refer to the upper limit of the froth dept and “lower froth layer surface” may refer to the lower limit of the froth dept.

Additionally, “lip” may refer to the end of a launder, wherein the launder is arranged such that froth, and/or liquid, and/or a slurry in a flotation tank may overflow the end of the launder.

In this disclosure, “vertically” may mean the direction of gravity and “horizontal” may mean the direction that is perpendicular to the vertical direction. For the avoidance of doubt, the bottom and top of a flotation tank is considered to substantially extend in the horizontal directions and the one or more wall(s) of a flotation tank is considered to substantially extend in the vertical direction.

Further, “the perimeter” of a flotation tank may refer to the closed path that encompasses, surrounds, or outlines the flotation tank.

### BRIEF DESCRIPTION OF THE DRAWINGS

The present disclosure will be better understood from the following detailed description read in light of the accompanying drawings, wherein:

FIG. 1 shows a cross section of a froth flotation unit comprising a near coarse launder, wherein the near coarse launder is submerged in the flotation tank, and

FIG. 2 shows a cross section of a froth flotation tank comprising a near coarse launder, wherein the near coarse launder creates a protrusion in the flotation tank.

### DETAILED DESCRIPTION

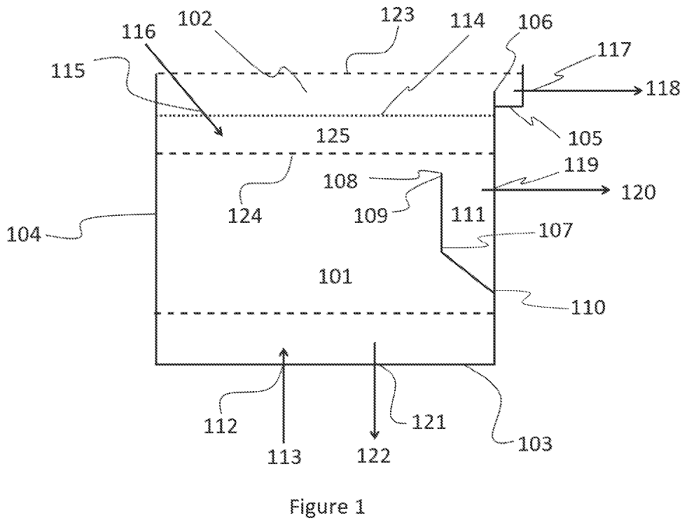

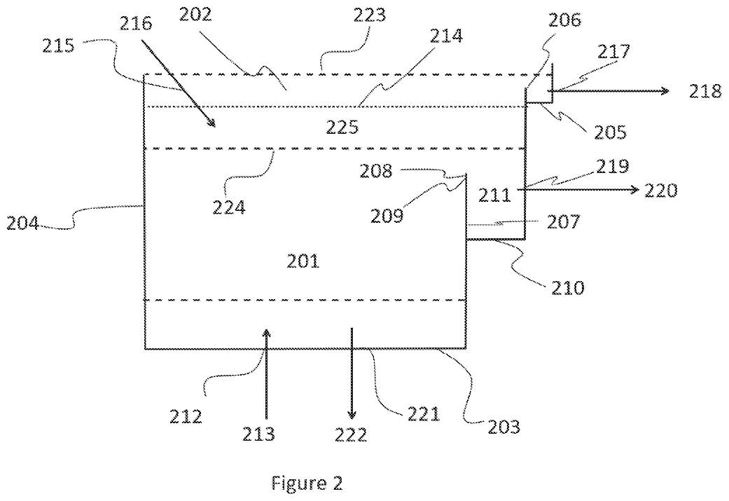

According to a first aspect and as illustrated in FIGS. 1 and 2, a froth flotation unit is provided, the froth flotation unit comprising:
a flotation tank (101, 201) having a top (102, 202), bottom (103, 203) and one or more wall(s) (104, 204);
a froth collecting launder (105, 205) having a froth overflow lip (106, 206); and
a near coarse launder (107, 207) having a second lip (108, 208);
wherein the second lip (108, 208) is arranged closer to the bottom (103, 203) of the flotation tank (101, 201) than the froth overflow lip (106, 206).

The froth flotation unit may be configured to treat mineral ore particles and coarse mineral ore particles suspended in slurry and to separate slurry into a first overflow (118, 218), a second overflow (120, 220) and an underflow (122, 222). The flotation tank (101, 201) may be circular or rectangular. If the flotation tank (101, 201) is circular, the flotation tank (101, 201) may comprise one wall (104, 204). If the flotation (101, 201) tank is rectangular, the flotation tank (101, 201) may comprise 4 walls (104, 204). The froth flotation unit may be a mechanically agitated flotation unit or a pneumatic flotation unit, such as a column flotation unit.

The flotation tank (101, 201) of the froth flotation unit according to the first aspect may comprise a froth layer zone (125, 225) having an upper froth layer surface (123, 223), a lower froth layer surface (124, 224) and a central froth layer cross section (114, 214).

The froth layer zone (125, 225) may be measurable as a vertical distance between the froth overflow lip (106, 206) or the top (102, 202) of the flotation tank (101, 201) and the surface of a slurry in a flotation tank, when said flotation tank is in use. However, the skilled person will understand that since froth is overflowing the froth overflow lip (106, 206) when said flotation tank is in use, the froth layer zone (125, 225) may extend slightly above the froth overflow lip (106, 206). The froth layer zone (125, 225) may completely or partially cover the entire horizontal surface area between the one or more wall(s) (104, 204) of the flotation tank (101, 201).

The froth collecting launder (105, 205) of the froth flotation unit according to the first aspect may be arranged at the one or more wall(s) (104, 204) of the flotation tank (101, 201).

The froth collecting launder (105, 205) may completely or partially cover the perimeter formed by the one or more wall(s) (104, 204) of the flotation tank (101, 201).

In one embodiment, the froth collecting launder (105, 205) is configured for allowing particles present in the froth in froth flotation to overflow the froth overflow lip (106, 206) of the froth collecting launder (105, 205) to obtain a first overflow (118, 218). The froth collecting launder (105, 205) may be arranged outside or inside the one or more wall(s) (104, 204) of the flotation tank (101, 201). The froth collecting launder (105, 205) may completely or partially cover the perimeter formed by the one or more wall(s) (104, 204) of the flotation tank (101, 201) such that the froth collecting launder (105, 205) extends continuously along the perimeter of the one or more wall(s) (104, 204) of the flotation tank (101, 201) or such that 2, or 3, or 4 froth collecting launders (105, 205) are arranged at the one or more wall(s) (104, 204) of the flotation tank (101, 201).

The froth overflow lip (106, 206) of the froth flotation unit according to the first aspect may be located in the froth layer zone (125, 225), preferably above the central froth layer cross section (114, 214) of the flotation tank (101, 201).

It has been found that the aforementioned location of the froth overflow lip (106, 206) has the added utility that an optimal amount of particles may be recovered through the froth collecting launder (105, 205) in froth flotation.

The near coarse launder (107, 207) of the froth flotation unit according to the first aspect may be arranged at the one or more wall(s) (104, 204) of the flotation tank (101, 201).

The near coarse launder (107, 207) may completely or partially cover the perimeter formed by the one or more wall(s) (104, 204) of the flotation tank (101, 201).

The near coarse launder (107, 207) may be arranged inside the one or more wall(s) (104, 204) of the flotation tank (101, 201). The near coarse launder (107, 207) may completely or partially cover the perimeter formed by the one or more wall(s) (104, 204) of the flotation tank (101, 201) such that the near coarse launder (107, 207) extends continuously along the perimeter of the one or more wall(s) (104, 204) of the flotation tank (101, 201) or such that 2, or 3, or 4 near coarse launders (107, 207) are arranged at the one or more wall(s) (104, 204) of the flotation tank (101, 201).

The near coarse launder (107, 207) of the froth flotation unit according to the first aspect may comprise a barrier having a lip end (109, 209) comprising the second lip (108, 208) and a bottom end (110, 210), wherein the bottom end (110, 210) of the barrier may be attached to the one or more wall(s) (104, 204) of the flotation tank (101, 201), and wherein the barrier may be configured to create an open space (111, 211) between the one or more wall(s) (104, 204) of the flotation tank (101, 201) and the barrier.

In one embodiment, the near coarse launder (107, 207) consists of the barrier having a lip end (109, 209) comprising the second lip (108, 208) and a bottom end (110, 210). For the avoidance of doubt, the lip end (109, 209) of the barrier may form the second lip (108, 208).

The barrier of the froth flotation unit according to the first aspect may be configured for directing coarse particles in froth flotation to the open space (111, 211) for collection.

The bottom end (110, 210) of the barrier of the froth flotation unit according to the first aspect may be attached to the one or more wall(s) (104, 204) of the flotation tank (101, 201) and the lip end (109, 209) of the barrier may extend towards the top (102, 202) of the flotation tank (101, 201) such that the lip end (109, 209) of the barrier may be located at a radial distance of 1/500 D to 4/9 D from the one or more wall(s) (104, 204) of the flotation tank (101, 201), wherein D is the length of the largest horizontal cross-section of the flotation tank (101, 201).

The lip end (109, 209) of the barrier may be located at a radial distance of 1/400 D to 3/9 D, or 1/350 D to 2/9, for example 1/350 D to 1/250 D from the one or more wall(s) (104, 204) of the flotation tank (101, 201).

The lip end (109, 209) of the barrier of the froth flotation unit according to the first aspect may be located in the froth layer zone (125, 225), preferably below the central froth layer cross section (114, 214) of the flotation tank (101, 201).

The lip end (109, 209) of the barrier of the froth flotation unit according to the first aspect may be located below the lower froth layer surface (124, 224) of the flotation tank (101, 201).

The bottom end (110, 210) of the barrier of the froth flotation unit according to the first aspect may be located below the central froth layer cross section (114, 214) of the flotation tank (101, 201).

The length of the launder(s) (105, 205, 107, 207) may be designed such that the product collected, has a concentration of desired material(s) that is between the overflow and the underflow grade.

The distance between the lip end (109, 209) and the bottom end (110, 210) of the barrier may be ⅓ to ⅕ of the height of the froth depth.

The near coarse launder (107, 207) may have an L-shape or U-shape or anything between an L-shape and U-shape. The angle of the L-shape can deviate from 90°.

The inventors have surprisingly found that coarse particles may be recovered in froth flotation through the above near coarse launder (107, 207). Without wishing to be bound by theory, it is believed that coarse particles in froth flotation do not move to the top of the froth layer but stay lower in the froth and eventually sink towards the bottom (103, 203) of the flotation tank (101, 201). It has been found that the vertical and horizontal positioning of the second lip (108, 208) in relation to the inner space of the flotation tank (101, 201) provides optimal conditions for recovering the coarse particles. Further, it has been found that the positioning of the second lip (108, 208) does not disturb the operation of the froth overflow lip (106, 206). Specifically, the inventors have surprisingly found that positioning of the lip end (109, 209) of the barrier below the lower froth layer surface (124, 224) gives the advantage of recovering coarse particles with low ore liberation that are not reaching the froth layer. Positioning the lip end (109, 209) of the barrier in the froth layer zone (125, 225), preferably below the central froth layer cross section (114, 214) of the flotation tank (101, 201), gives the advantage of recovering coarse particles with low ore liberation that are not reaching the froth overflow lip (106, 206).

The inventors have also found that by including both the froth collecting launder (105, 205) and the near coarse launder (107, 207) in the same flotation cell (101, 201), both particles within the range of approximately 20 μm to 150 μm and particles of a size of greater than 150 μm can be simultaneously recovered.

The near coarse launder (107) may be submerged in the flotation tank (101) as seen in FIG. 1. Alternatively, the near coarse launder (207) may create a protrusion in the flotation tank (201) as seen in FIG. 2 such that the one or more wall(s) (204) of the flotation tank (201) conform the near coarse launder (207).

The froth flotation unit according to the first aspect may further comprise a gas supply (112, 212) for introducing flotation gas (113, 213) into a slurry in the flotation tank (101, 201) to form a froth layer in the froth layer zone (125, 225) and a feeding device (115, 215) for feeding slurry (116, 216) above the froth layer zone (125, 225), and/or in the froth layer zone (125, 225), and/or into the froth slurry interface, and/or under the froth layer zone (125, 225) in proximity thereof, e.g., at most two times the froth depth, or at most the froth depth, or at most ½ of the froth depth, or at most ⅕ of the froth depth, or at most 1/10 of the froth depth under said froth layer zone (125, 225) in the flotation tank (101, 201).

The gas supply (112, 212) may be arranged in connection with a mixing device.

Alternatively, the gas supply (112, 212) may comprise gas inlets, such as nozzles or spargers, configured to introduce flotation gas (113, 213) into the flotation tank (101, 201). The gas supply (112, 212) may be arranged at any height in the flotation tank, e.g. in the bottom (103, 203) of the flotation tank (101, 201).

The feeding device (115, 215) may be arranged above the froth layer zone (125, 225), and/or in the froth layer zone (125, 225), and/or in the froth slurry interface, and/or under the froth layer zone (125, 225) in proximity thereof, e.g., at most two times the froth depth, or at most the froth depth, or at most ½ of the froth depth, or at most ⅕ of the froth depth, or at most 1/10 of the froth depth under and/or on top of the froth layer zone (125, 225) in the flotation tank (101, 201). The feeding device (115, 215) may be configured to feed slurry (116, 216) above the froth layer zone (125, 225), into the froth layer zone (125, 225), and/or into the froth slurry interface, and/or under the froth layer zone (125, 225) or in close proximity thereof during the operation of the flotation unit.

The froth flotation unit according to the first aspect may further comprises first overflow means (117, 217) for discharging a first overflow (118, 218) from the froth collecting launder (105, 205), and second overflow means (119, 219) for discharging a second overflow (120, 220) from the near coarse launder (107, 207).

The first overflow (118, 218) may comprise mineral ore particles and the second overflow (120, 220) may comprise coarse mineral ore particles. The first overflow means (117, 217) and second overflow means (119, 219) may comprise an outlet and a pump or a valve.

The froth flotation unit according to the first aspect may further comprises discharge means (121, 221) for discharging underflow (122, 222) from the flotation tank (101, 201).

The underflow (122, 222) may comprise tailings. The discharge means (121, 221) may comprise an outlet and a pump or a valve. The discharge means (121, 221) may be arranged at the bottom (103, 203) or in the one or more wall(s) (104, 204) near the bottom (103, 203) of the flotation tank (101, 201).

According to a second aspect, a froth flotation method for treating coarse particles suspended in slurry is provided, wherein the slurry is separated into a first overflow (118, 218), a second overflow (120, 220) and an underflow (122, 222) in a froth flotation unit (101, 201) according to the first aspect.

In the froth flotation method according to the second aspect, the first overflow (118, 218) may comprise overflow from the froth collecting launder (105, 205) and the second overflow (120, 220) may comprise overflow from the near coarse launder (107, 207).

The flotation unit may be operated as follows. A froth layer is formed in the froth layer zone (125, 225) in the top part of the flotation tank (101, 201) by introducing flotation gas (113, 213) into slurry in the flotation tank (101, 201). Slurry (116, 216) is fed to the froth layer.

Hydrophobic particles contained in the slurry feed adhere to the flotation gas (113, 213) bubbles in the froth layer. The bubble-particle agglomerates are removed from the flotation tank (101, 201) over the froth overflow lip (106, 206) and passed into the froth collection launder (105, 205) with the first overflow (118, 218). Hydrophilic particles pass through the froth layer zone (125, 225) to the slurry below it. Coarse bubble-particle agglomerates that have passed through the froth layer zone (125, 225) but are still agglomerated and comprise at least partially hydrophobic particles are removed from the flotation tank (101, 201) over the second lip (108, 208) and passed into the near coarse launder (107, 207) with the second overflow (120, 220). Particles not recovered are discharged from the flotation tank (101, 201) with the underflow (122, 222).

It is obvious to a person skilled in the art that with the advancement of technology, the basic idea of the invention may be implemented in various ways. The invention and its embodiments are thus not limited to the examples described above, instead they may vary within the scope of the claims.

1. A froth flotation unit, comprising:
a flotation tank having a top, bottom and one or more wall(s);
a froth collecting launder having a froth overflow lip; and
a near coarse launder having a second lip;
wherein the second lip is arranged closer to the bottom of the flotation tank than the froth overflow lip.

2. The froth flotation unit according to claim 1, wherein the flotation tank comprises a froth layer zone having an upper froth layer surface, a lower froth layer surface and a central froth layer cross section.

3. The froth flotation unit according to claim 1, wherein the froth collecting launder is arranged at the one or more wall(s) of the flotation tank.

4. The froth flotation unit according to claim 2, wherein the froth overflow lip is located in the froth layer zone, preferably above the central froth layer cross section of the flotation tank.

5. The froth flotation unit according to claim 1, wherein the near coarse launder is arranged at the one or more wall(s) of the flotation tank.

6. The froth flotation unit according to claim 2, wherein the near coarse launder comprises a barrier having a lip end comprising the second lip and a bottom end, wherein the bottom end of the barrier is attached to the one or more wall(s) of the flotation tank, and wherein the barrier is configured to create an open space between the one or more wall(s) of the flotation tank and the barrier.

7. The froth flotation unit according to claim 6, wherein the barrier is configured for directing coarse particles in froth flotation to the open space for collection.

8. The froth flotation unit according to claim 6, wherein the bottom end the barrier is attached to the one or more wall(s) of the flotation tank and the lip end of the barrier extends towards the top of the flotation tank such that the lip end of the barrier is located at a radial distance of 1/500 D to 4/9 D from the one or more wall(s) of the flotation tank, and wherein D is the length of the largest horizontal cross-section of the flotation tank.

9. The froth flotation unit according to claim 8, wherein the lip end of the barrier is located in the froth layer zone, preferably below the central froth layer cross section of the flotation tank.

10. The froth flotation unit according to claim 8, wherein the lip end of the barrier is located below the lower froth layer surface of the flotation tank.

11. The froth flotation unit according to claim 2, wherein the froth flotation unit further comprises a gas supply for introducing flotation gas into a slurry in the flotation tank to form a froth layer in the froth layer zone and a feeding device for feeding slurry into and/or on top of the froth layer zone in the flotation tank.

12. The froth flotation unit according to claim 1, wherein the froth flotation unit further comprises first overflow means for discharging a first overflow from the froth collecting launder, and second overflow means for discharging a second overflow from the near coarse launder.

13. The froth flotation unit according to claim 1, wherein the froth flotation unit further comprises discharge means for discharging underflow from the flotation tank.

14. A froth flotation method for treating coarse particles suspended in slurry, wherein the slurry is separated into a first overflow, a second overflow and an underflow in the froth flotation unit according to claim 1.

15. The froth flotation method according to claim 14, wherein the first overflow comprises overflow from the froth collecting launder and the second overflow comprises overflow from the near coarse launder.
